(19) United States
(12) Patent Application Publication
(10) Pub. No.: US 2009/0250451 A1
(43) Pub. Date: Oct. 8, 2009

(54) AUTO STIR

(75) Inventor: Christopher Blackson, Uniontown, OH (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS INC., Cleveland, OH (US)

(21) Appl. No.: 12/061,842

(22) Filed: Apr. 3, 2008

(51) Int. Cl. A21B 1/26; F24C 7/08; F24C 15/32; F24C 15/00

(52) U.S. Cl. 219/400

(57) ABSTRACT

A cooking method includes operation of a convection fan and a bake heating element to stir heat within an oven cavity.

### BACKGROUND OF THE INVENTION

1) Field of the Invention

The present invention relates to use of a convection fan during a radiant bake cooking operation.

2) Description of Prior Art

Typically after food racks are provided into a preheated oven cavity in conventional normal bake, radiant cooking operations for multiple rack short term cooking items (e.g., cookies, biscuits, etc.), there is a significant temperature differential between the center of the oven and the top of the oven chassis in which the oven probe is located. The differential is generally about 50-degrees F. This temperature differential degrades cooking performance for these short term cooking items. For instance, the short term foods at the top rack are cooked significantly more than the foods provided in the bottom portion of the oven cavity.

Using a convection bake typically minimizes temperature differentials within a cooking cavity. However, convection baking is not recommended for short term food items as convection baking ‘seals’ an outside portion of the food, or in other words forming a crust, which is typically undesirable in short term foods.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a method of stirring heat in a cooking appliance is provided. The method includes: activating a bake element in the cooking appliance; and activating a fan in the cooking appliance, the fan being adapted to stir heat provided by the bake element within a cavity of the cooking appliance.

In accordance with another aspect of the present invention, a method of operating a cooking appliance is provided. The method includes: preheating a cavity of the cooking appliance to a desired temperature; activating heating means to heat food items in the cooking appliance during a cooking operation; and periodically cycling a convection fan to minimize temperature differentials within the cavity of the cooking appliance, wherein the heating means is not a convection element.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings.

FIG. 1 illustrates a front view of a cooking cavity in a conventional cooking appliance.

FIG. 2 illustrates a cooking appliance in accordance with an aspect of the present invention.

FIG. 3 illustrates an upper cavity of a cooking appliance in accordance with an aspect of the present invention.

FIG. 4 illustrates a methodology of performing a stir function in a cooking appliance in accordance with an aspect of the present invention.

FIG. 5 illustrates another methodology of performing a stir function in a cooking appliance in accordance with an aspect of the present invention.

### DESCRIPTION OF AN EXAMPLE EMBODIMENT

The present invention relates to use of a convection fan during a radiant bake cooking operation. The present invention will now be described with reference to the drawings, wherein like reference numerals are used to refer to like elements throughout. It is to be appreciated that the various drawings are not drawn to scale from one figure to another nor inside a given figure, and in particular that the size of the components are arbitrarily drawn for facilitating the reading of the drawings. In the following description, for purposes of explanation, numerous specific details are set forth in order to provide a thorough understanding of the present invention. It may be evident, however, that the present invention may be practiced without these specific details.

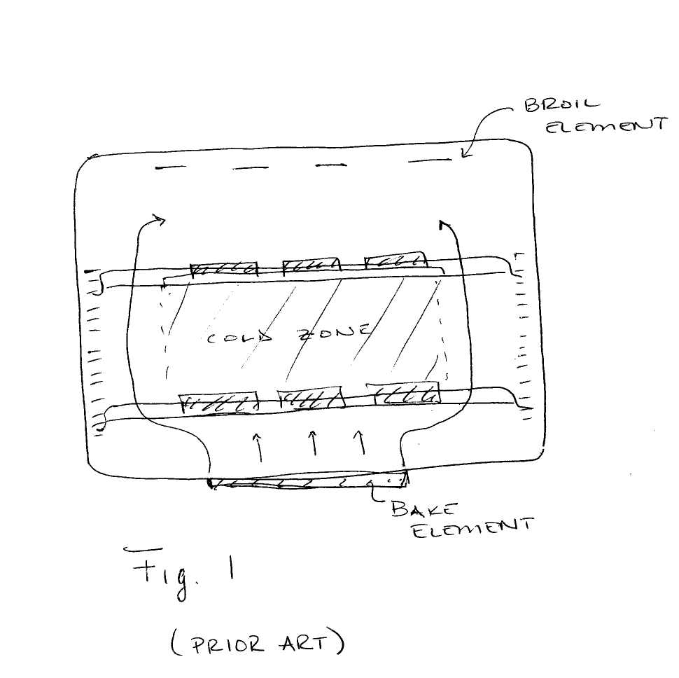

Referring initially to FIG. 1, a conventional cooking appliance is depicted. A cooking cavity of the appliance has two racks installed within the cavity, both racks having food pans provided thereon. As shown by the arrows, which depict movement of heat rising from a bake element, heat movement is blocked by the bottom food pan, thereby creating a cold zone between the two racks. This cold zone prevents the food items on the lower rack pan from cooking at the same temperature as the food items on the upper rack. As stated in the background section, this temperature differential in the cold zone can be about 50-degrees F cooler than the surrounding areas in the cooking cavity.

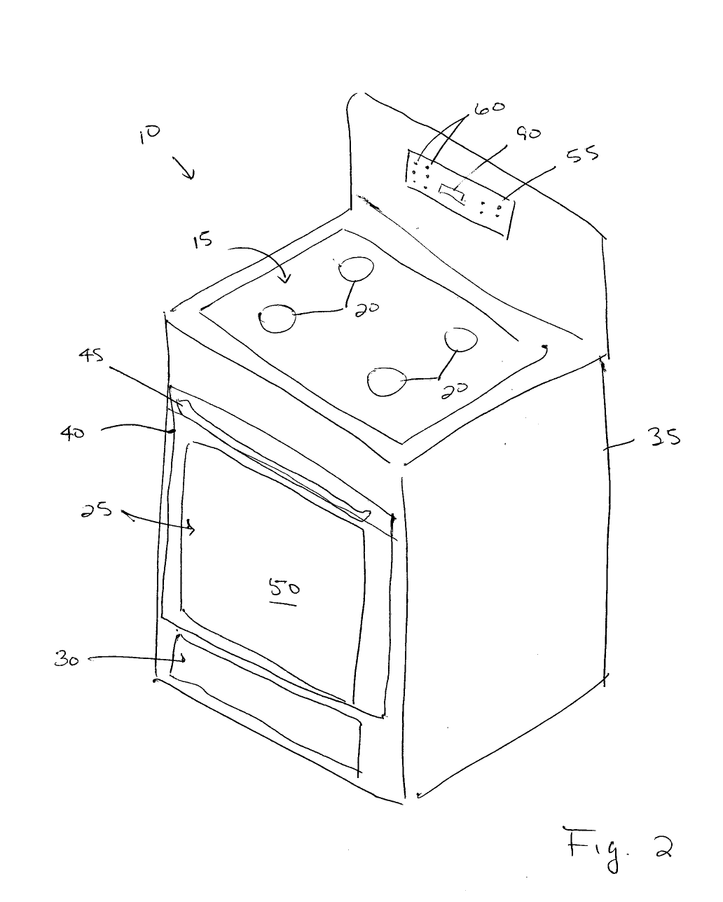

FIG. 2 illustrates a cooking appliance in accordance with an aspect of the present invention. Although a free-standing range is described herein, it is to be appreciated that the cooking appliance can be any suitable cooking appliance, such as a double wall oven, cabinet mounted oven, slide-in, or the like. The cooking appliance 10 includes a range portion 15 having a plurality of heating elements, gas and/or electric, 20. The cooking appliance 10 further includes an upper cavity portion 25 and a lower cavity portion 30. The upper cavity 25 is preferably designed to include a plurality of heating elements, such as a broil heating element, a radiant heat cooking element, and a convection element. The lower cavity portion 30 preferably includes another radiant heat cooking element, which can be used as a warming drawer. The appliance 10 includes an outer frame 35 for supporting the range portion 15, upper cavity portion 25, and lower cavity portion 30.

A door assembly 40 is provided to selectively allow access to the upper oven cavity 25. As shown, the door assembly 40 is provided with a handle 45 at an upper portion thereof. The door assembly 40 is adapted to pivot at a lower portion in order to allow selective access to within oven cavity 25. In a manner also known in the art, door 40 is provided with a window portion 50 for viewing the contents of oven cavity 25 while the door 40 is closed.

As further shown in FIG. 2, the cooking appliance 10 includes a control panel 55 having a plurality of control elements 60. In accordance with one aspect, the control elements 60 include range and oven control buttons and a numeric pad. Operatively coupled to the control panel 55 is an electronic control unit (ECU) including a central processing unit (CPU) with a memory module. The ECU is adapted to receive inputs from a user and, subsequently, control a desired cooking operation of appliance 10. For example, the ECU can receive inputs through control elements 60 and, in combination with numeric pad and a display 90, allow a user to establish particular cooking operations for the upper and lower cavities 25 and 30. Since the general programming and operation of cooking appliance 10 is within the skill of an ordinary artisan in this art, these features will not be discussed further herein.

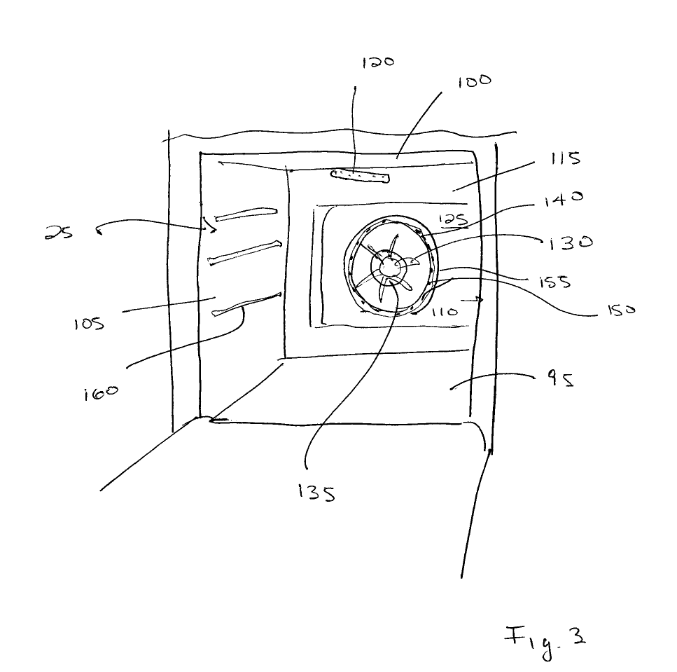

As best seen in FIG. 3, the upper oven cavity 25 is defined by a bottom portion 95, a top portion 100, opposing side portions 105 and 110, and a rear portion 115. The bottom portion 95 can have a flat, smooth surface for purposes of cleanability, serviceability, and reflective qualities of oven cavity 25. A broil element 120 is coupled to the top portion 100 of the oven cavity 25. The broil element 120 is provided to enable a consumer to perform a broiling or grilling process in the upper oven cavity 25 and also aids in pyrolytic heating during a self-clean operation. A bake element (not shown) is arranged below the bottom portion 95 of the oven cavity 25. The bottom portion 95 includes a removable segment so as to provide access to the bake element. It is to be appreciated that the bake element can be exposed, if desired. The bake element is provided to perform a baking operation in oven cavity 25. In addition to broil and bake elements, the upper oven cavity 25 is provided with a convection heating system to provide both convection heating techniques for cooking food items therein. The rear portion 115 of the upper cavity 25 includes a recessed portion or convection air plenum 125 within which is arranged a convection fan or blower 130 having an associated central inlet or intake zone 135 arranged about a vented cover 140, and an outlet 145. The convection fan 130 can be a variable speed fan configured to operate at high, medium, and low speeds. Although the exact position and construction of fan 130 can readily vary in accordance with the invention, in accordance with one aspect, the fan 130 draws in air at a central intake zone 135 of the vented cover 140 and directs the air into oven cavity 25 in a radial outward direction through outlets 150. Also, a sheathed electric heating element 155, which typically can be in the form of a ring, extends circumferentially about fan 130. More specifically, convection heating element 155, which forms part of the convection heating system, is provided to heat radially directed airflow from the convection fan 130. Food is placed on removable oven racks (not shown) that can be positioned on one or more rack glides 160 for heating by the baking element or convection bake element 155, or for heating by the broiler element 120.

In accordance with an aspect of the present invention, the convection fan 130 is operated with or in sequence with the bake element to minimize normal bake temperature differentials of the cavity 25 after food is placed in the oven 10. Using the convection fan 130 with the bake element operates to minimize the aforementioned temperature differential problem of the prior art, as the fan 130 stirs, or moves the heat, in the oven cavity 25. This method of stirring the heat in the oven cavity 25 allows more even heating within the cavity 25 and more particularly, over food items provided on a bottom rack. Accordingly, multiple racks in a normal bake cooking operation can be utilized for short term cooking items.

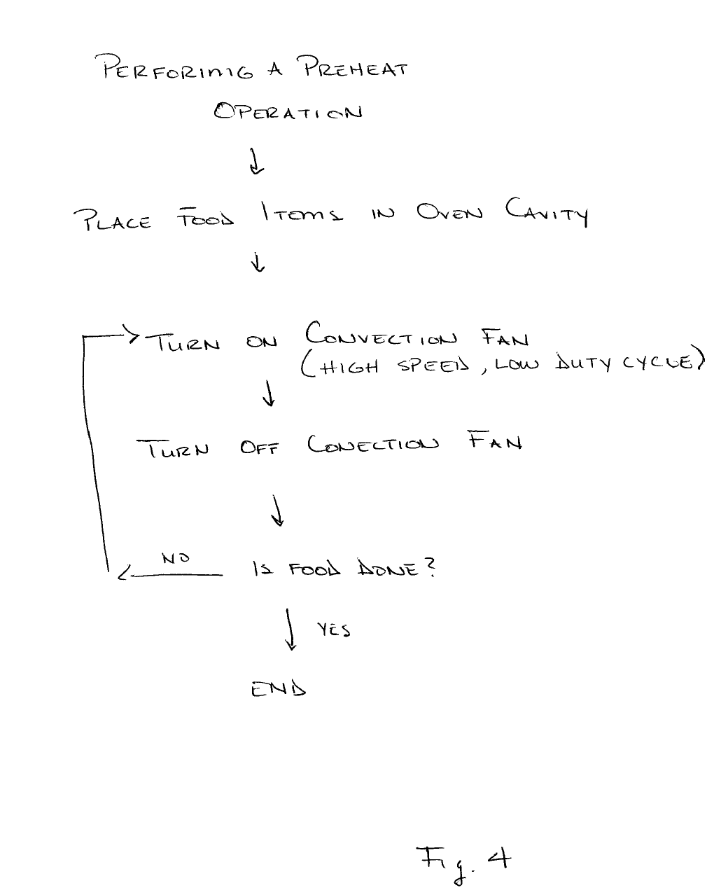

Turning now to FIG. 4, a methodology is provided for cooking short term food items in an oven cavity in accordance with an aspect of the present invention. The method begins with performing a preheat operation. The preheat operation can include turning on the bake heating element in addition to any other suitable heating elements, such as the broil heating element and/or the convection heating element. Thus, it is to be appreciated that any suitable preheat operation can be employed in accordance with the present invention. After the oven cavity is sufficiently preheated, food items are placed within the cavity. The food items can be positioned on one or more baking racks. A bake heating element is on to provide a substantially constant temperature within the oven cavity. A convection fan is turned on periodically at a higher speed and a lower duty cycle to minimize temperature differentials within the preheated cavity. Preferably, the convection fan is on from about 10 to 15 seconds and off from about 45 to 50 seconds. This cycling on and off operates to ‘stir’ the heat within the oven cavity.

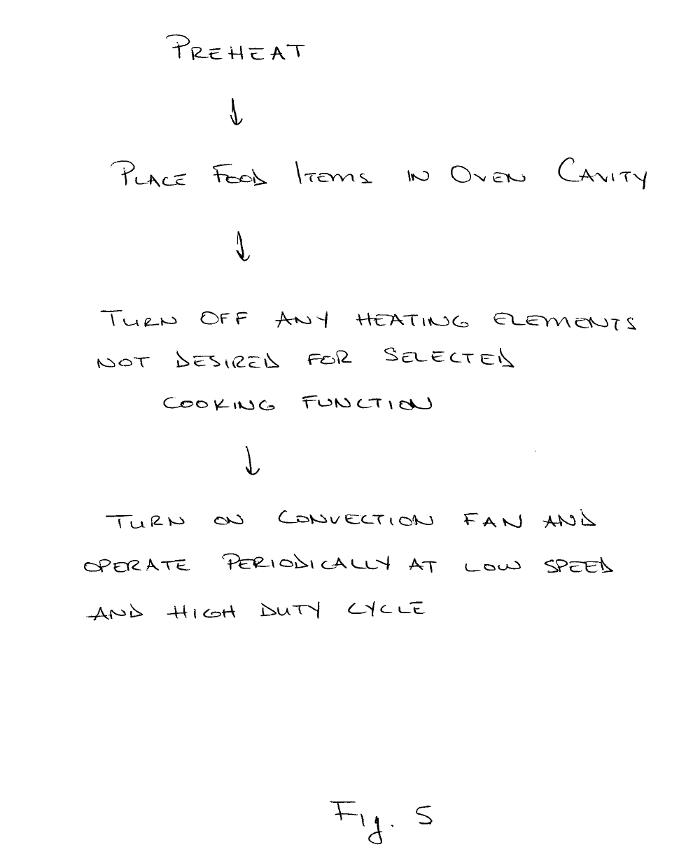

Turning now to FIG. 5, another method is provided for cooking short term food items in an oven cavity in accordance with an aspect of the present invention. The method begins with performing a preheat operation. As stated above, the preheat operation can include turning on the bake heating element in addition to any other suitable heating elements, such as the broil heating element and/or the convection heating element. After the oven cavity is sufficiently preheated, food items are placed within the cavity. The bake heating element is on. Any other heating elements not desired for the selected cooking function are turned off. A convection fan is turned on and is operated periodically at a lower speed and a higher duty cycle to perform the heat stirring function. For instance, the convection fan can be on from about 45 to 50 seconds and off from about 10 to 15 seconds, or any comparable variation thereof. This heat stirring provides substantially even heating of the food items within the oven cavity.

It is noted that the convection element is not operated during the herein described heat stirring functions in order to minimize any undesirable crust characteristics on the food items.

It is to be appreciated that the stirring function can be performed by a combination of both of the above-described methods. Further, the stirring function can be performed by operating the fan at any desired speed and duty cycle, such as at a low speed and low duty cycle or at a high speed and high duty cycle or at a medium speed and either of a low or high duty cycle. Further still, it is to be appreciated that the stirring function can be performed by operating the convection fan during the entire cooking operation. Moreover, any suitable method of operating both the convection fan and the bake element to achieve a suitable cooking operation for short term food items is contemplated as falling within the scope of the present invention.

What has been described above includes example implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations of the present invention.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A method of stirring heat in a cooking appliance comprising:
activating a bake element in the cooking appliance; and
activating a fan in the cooking appliance, the fan being adapted to stir heat provided by the bake element within a cavity of the cooking appliance.

2. The method of claim 1, further comprising activating a preheat operation.

3. The method of claim 2, further comprising placing food items in the cavity of the cooking appliance after the cavity is sufficiently preheated.

4. The method of claim 1, wherein the convection element is not activated.

5. The method of claim 1, wherein the fan is a convection fan.

6. The method of claim 1, wherein the fan is operated at a high speed and low duty cycle.

7. The method of claim 1, wherein the fan is operated at a high speed and high duty cycle.

8. The method of claim 1, wherein the fan is operated at a medium speed and low duty cycle.

9. The method of claim 1, wherein the fan is operated at a medium speed and high duty cycle.

10. The method of claim 1, wherein the fan is operated at a high speed and low duty cycle.

11. The method of claim 1, wherein the fan is operated at a high speed and high duty cycle.

12. The method of claim 1, wherein the fan is a convection fan and is operated periodically at a high speed.

13. The method of claim 12, wherein the fan operates at a duty cycle of about 10 seconds to 15 seconds on and about 45 seconds to 50 seconds off.

14. The method of claim 1, wherein the fan is a convection fan and is operated periodically at a low speed.

15. The method of claim 14, wherein the fan operates at a duty cycle of about 10 seconds to 15 seconds off and about 45 seconds to 50 seconds on.

16. A method of operating a cooking appliance comprising:
preheating a cavity of the cooking appliance to a desired temperature;
activating heating means to heat food items in the cooking appliance during a cooking operation; and
periodically cycling a fan to minimize temperature differentials within the cavity of the cooking appliance,
wherein the heating means is not a convection element.

17. The method of claim 16, wherein the heating means is a bake element.

18. The method of claim 16, wherein the fan is a convection fan.

19. The method of claim 16, wherein the fan is operated in accordance with a duty cycle wherein the fan is on for about 10 to 15 seconds and off for about 45-50 seconds.
